(19) United States
(12) Patent Application Publication
(10) Pub. No.: US 2016/0270582 A1
(43) Pub. Date: Sep. 22, 2016

(54) Pot Lid Structure

(71) Applicant: Junhong Sam LU, GUANGDONG PROVINCE (CN)

(72) Inventor: Junhong Sam LU, GUANGDONG PROVINCE (CN)

(21) Appl. No.: 14/658,250

(22) Filed: Mar. 16, 2015

(51) Int. Cl. A47J 31/38

(52) U.S. Cl. CPC A47J 31/38

(57) ABSTRACT

A pot lid structure having a pot lid body, a water outlet manipulating rod, a resetting spring and a water outlet control disc; one end of the water outlet manipulating rod is hinged on the pot lid body and the other end is penetrated out of the pot lid body; the water outlet control disc is installed at the bottom of the pot lid body and the top of the water outlet control disc is connected to the middle of the water outlet manipulating rod so that the water outlet control disc is controlled to perform a water outlet action or a water stopping action; and the resetting spring is arranged between the water outlet manipulating rod and the water outlet control disc so that the water outlet manipulating rod and the water outlet control disc are automatically reset upwards.

### BACKGROUND OF THE INVENTION

The utility model relates to a teapot or coffeepot product, and more particularly to a pot lid component of a teapot or a coffeepot.

At present, in the existing pot lid structure of which the water pouring outlet is blocked through a lever principle, the water pouring outlet on the pot lid is blocked mainly by means of the front part of a lever control rod, so that at the time of pouring water, the front part of the lever control rod is tilted upwards by pressing the end part of the lever control rod down and the water pouring outlet is opened for realizing the purpose of pouring the water. Such a pot lid product has the main defect that: the heat preservation effect and the constant temperature effect are poor caused by poorer airtightness and sealing performance of the entire pot product because the water outlet on the pot lid is blocked only by means of the front part of the control rod.

### BRIEF SUMMARY OF THE INVENTION

The aim of the utility model is to provide a pot lid structure with scientific structural design, good airtightness, good heat preservation effect and good constant temperature effect.

The technical solution in the utility model is realized by that:

A pot lid structure, which is characterized by comprising a pot lid body, a water outlet manipulating rod, a resetting spring and a water outlet control disc, wherein one end of the water outlet manipulating rod is hinged on the pot lid body and the other end of the water outlet manipulating rod is penetrated out of the pot lid body to form a lever type manipulating and assembling structure; the water outlet control disc is installed at the bottom of the pot lid body and the top of the water outlet control disc is connected to the middle of the water outlet manipulating rod for realizing that the water outlet control disc is controlled by the water outlet manipulating rod to perform a water outlet action or a water stopping action; the resetting spring is arranged between the water outlet manipulating rod and the water outlet control disc for realizing that the water outlet manipulating rod and the water outlet control disc are automatically reset upwards; and a faucet is also made in the pot lid body.

In order that the water outlet control disc can be simply and conveniently assembled and connected together with the water outlet manipulating rod, a connecting column is arranged on the above-mentioned water outlet control disc, a column hole is made correspondingly in the above-mentioned pot lid body, and the water outlet control disc is installed at the bottom of the pot lid body by being sleeved with the column hole through the connecting column of the water outlet control disc; a sleeving hole is also arranged in the middle of the above-mentioned water outlet manipulating rod and the sleeving hole is sleeved with the top of the connecting column; and the above-mentioned resetting spring is sleeved on the connecting column.

In order that the water outlet manipulating rod can be simply and reliably installed on the pot lid body, a cavity is also arranged at the top of the above-mentioned pot lid body; a hinging seat is also arranged in the cavity, and a through hole is also made in the cavity wall of the cavity; and one end of the above-mentioned water outlet manipulating rod is hinged with the hinging seat, and the other end of the water outlet manipulating rod penetrates through the through hole and is arranged outside the pot lid body to form an operating end part for people to press.

The technical effect of the utility model is that:

Because of the adoption of the pot lid structure which comprises the pot lid body, the water outlet manipulating rod, the resetting spring and the water outlet control disc, when the pot lid is applied to a pot product for use, the water outlet manipulating rod is pressed downwards by people to drive the water outlet control disc to move downwards and a water outlet gap is formed between the water outlet control disc and the bottom edge of the pot lid body so that the drinking liquid flows through the faucet on the pot lid body from the water outlet gap and is poured into a cup; but when the water outlet manipulating rod is released by people, the water outlet manipulating rod and the water outlet control disc are reset upwards under the action of the resetting spring so that the water outlet control disc clings closely to the bottom edge of the pot lid body, and the water outlet gap is closed so that the drinking liquid in the pot is stopped without being poured out. In the pot lid, the structure of pouring out the drinking liquid is manipulated through the water outlet manipulating rod and the water outlet control disc. Compared with the existing lever type principle structure, the pot lid structure of the utility model not only has scientific structural design, good airtightness, good heat preservation effect and good constant temperature effect, but also has the features of simple structure, convenient assembly, easy realization and the like.

The utility model is further described in combination with the accompanying drawings.

### BRIEF DESCRIPTION OF THE DRAWINGS

FIG. 1 is a structural diagram of the section view of the utility model.

FIG. 2 is a structural diagram of the disassembly and the assembly of the utility model.

### DETAILED DESCRIPTION OF THE INVENTION

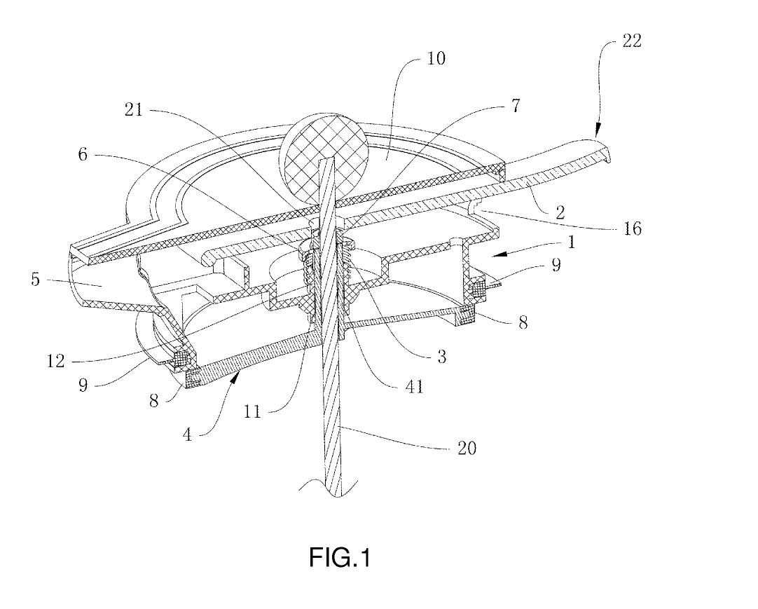

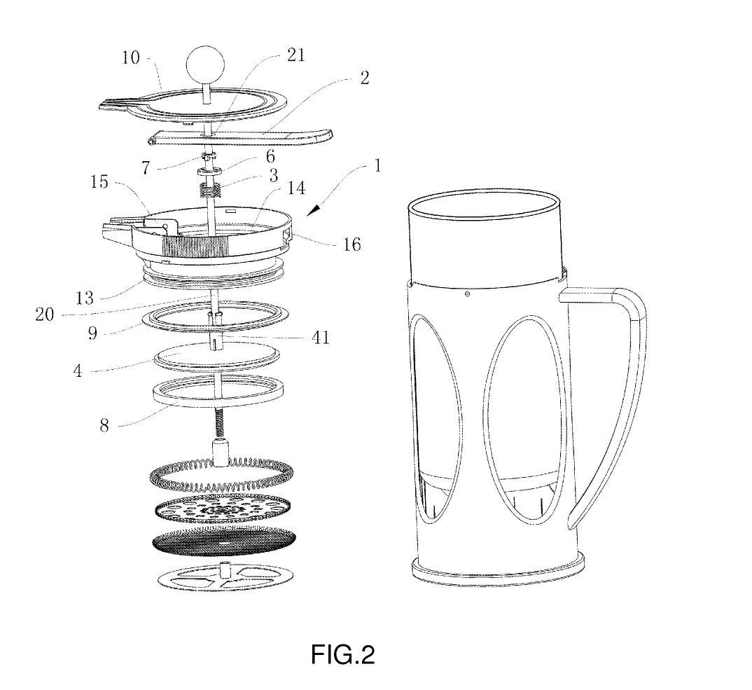

As shown in FIG. 1 and FIG. 2, the pot lid structure of the utility model comprises a pot lid body 1, a water outlet manipulating rod 2, a resetting spring 3 and a water outlet control disc 4, wherein one end of the water outlet manipulating rod 2 is hinged on the pot lid body 1 and the other end of the water outlet manipulating rod 2 is penetrated out of the pot lid body 1 to form a lever type manipulating and assembling structure; the water outlet control disc 4 is installed at the bottom of the pot lid body 1 and the top of the water outlet control disc 4 is connected to the middle of the water outlet manipulating rod 2 for realizing that the water outlet control disc 4 is controlled by the water outlet manipulating rod 2 to perform a water outlet action or a water stopping action; the resetting spring 3 is arranged between the water outlet manipulating rod 2 and the water outlet control disc 4 for realizing that the water outlet manipulating rod 2 and the water outlet control disc 4 are automatically reset upwards; and a faucet 5 is also made in the pot lid body 1.

In order that the water outlet control disc 4 can be simply and conveniently assembled and connected together with the water outlet manipulating rod 2, as shown in FIG. 1 and FIG. 2, a connecting column 41 is arranged on the water outlet control disc 4, a column hole 11 is made correspondingly in the pot lid body 1, and the water outlet control disc 4 is installed at the bottom of the pot lid body 1 by being sleeved with the column hole 11 through the connecting column 41 of the water outlet control disc 4; a sleeving hole 21 is also arranged in the middle of the water outlet manipulating rod 2 and the sleeving hole 21 is sleeved with the top of the connecting column 41; and the resetting spring 3 is sleeved on the connecting column 41.

In addition, in order that the assembly structure of the water outlet manipulating rod 2 and the water outlet control disc 4 is more reasonable and scientific, also as shown in FIG. 1 and FIG. 2, a spring cap 6 and a pressure grain 7 are also arranged between the connecting column 41 and the water outlet manipulating rod 2, wherein the spring cap 6 is pressed at the top of the resetting spring 3, the pressure grain 7 is installed at the top of the spring cap 6 and the top of the pressure grain 7 is sleeved with the sleeving hole 21 of the water outlet manipulating rod 2. In addition, a sleeving column 12 is also made at the top edge of the column hole 11 of the pot lid body 1 and the lower part of the resetting spring 3 is sleeved on the sleeving column 12. By means of such a matching structural design, the resetting spring 3 can be reliably installed between the water outlet manipulating rod 2 and the water outlet control disc 4 to form a better resetting action. In order to further improve the sealing performance with the bottom edge of the pot lid body 1 when the water outlet control disc 4 is reset upwards, as shown in the figures, a water stopping rubber ring 8 is also arranged at the disc edge of the water outlet control disc 4.

In order that the water outlet manipulating rod 2 can be simply, reasonably and reliably installed on the pot lid body 1, also as shown in FIG. 1 and FIG. 2, a cavity 14 is also arranged at the top of the pot lid body 1; a hinging seat 15 is also arranged in the cavity 14, and a through hole 16 is also made in the cavity wall of the cavity 14; and one end of the water outlet manipulating rod 2 is hinged with the hinging seat 15, and the other end of the water outlet manipulating rod 2 penetrates through the through hole 16 and is arranged outside the pot lid body 1 to form an operating end part 22 for people to press. Meanwhile, in order to shield the internal assembly of the pot lid body 1 so that the entire pot lid product is more beautiful, the pot lid body 1 is also provided with a surface lid 10 which can be covered on the pot lid body 1 and the surface lid 10 is generally made into a covering structure which is matched with the pot lid body 1.

In addition, according to the need for the function of the pot product, some related connecting components can also be arranged on the pot lid body 1. As shown in FIG. 1 and FIG. 2, when the pot product needs to have a separated filtration function, it is available that a connecting rod 20 which penetrates through the middle of the pot lid body 1 is arranged on the pot lid body 1, and the connecting rod 20 is generally made into an assembly structure which directly passes through the pot lid body 1 and various parts and components on the pot lid body 1.

In addition, when the pot lid product is installed on the pot product for application, in order to ensure the connection airtightness between the pot lid and the pot body (or a pot bottle), as shown in FIG. 1 and FIG. 2, a ring groove 13 is also arranged on the outer wall of the lower part of the pot lid body 1, and a sealing rubber ring 9 is installed in the ring groove 13.

What is claimed is:

1. A pot lid structure, which is characterized by comprising a pot lid body (1), a water outlet manipulating rod (2), a resetting spring (3) and a water outlet control disc (4), wherein one end of said water outlet manipulating rod (2) is hinged on the pot lid body (1) and the other end of the water outlet manipulating rod (2) is penetrated out of the pot lid body (1) to form a lever type manipulating and assembling structure; said water outlet control disc (4) is installed at the bottom of the pot lid body (1) and the top of the water outlet control disc (4) is connected to the middle of the water outlet manipulating rod (2) for realizing that the water outlet control disc (4) is controlled by the water outlet manipulating rod (2) to perform a water outlet action or a water stopping action; said resetting spring (3) is arranged between the water outlet manipulating rod (2) and the water outlet control disc (4) for realizing that the water outlet manipulating rod (2) and the water outlet control disc (4) are automatically reset upwards; and a faucet (5) is also made in said pot lid body (1).

2. The pot lid structure according to claim 1, which is characterized in that: a connecting column (41) is arranged on the above-mentioned water outlet control disc (4), a column hole (11) is made correspondingly in the above-mentioned pot lid body (1), and the water outlet control disc (4) is installed at the bottom of the pot lid body (1) by being sleeved with the column hole (11) through the connecting column (41) of the water outlet control disc (4); a sleeving hole (21) is also arranged in the middle of the above-mentioned water outlet manipulating rod (2) and the sleeving hole (21) is sleeved with the top of the connecting column (41); and the above-mentioned resetting spring (3) is sleeved on the connecting column (41).

3. The pot lid structure according to claim 2, which is characterized in that: a spring cap (6) and a pressure grain (7) are also arranged between the above-mentioned connecting column (41) and the water outlet manipulating rod (2), wherein said spring cap (6) is pressed at the top of the resetting spring (3), said pressure grain (7) is installed at the top of the spring cap (6) and the top of the pressure grain (7) is sleeved with the sleeving hole (21) of the water outlet manipulating rod (2).

4. The pot lid structure according to claim 2, which is characterized in that: a sleeving column (12) is also made at the top edge of the column hole (11) of the above-mentioned pot lid body (1) and the lower part of the above-mentioned resetting spring (3) is sleeved on the sleeving column (12).

5. The pot lid structure according to claim 1 or 2, which is characterized in that: a water stopping rubber ring (8) is also arranged at the disc edge of the above-mentioned water outlet control disc (4).

6. The pot lid structure according to claim 1, which is characterized in that: a cavity (14) is also arranged at the top of the above-mentioned pot lid body (1); a hinging seat (15) is also arranged in the cavity (14), and a through hole (16) is also made in the cavity wall of the cavity (14); and one end of the above-mentioned water outlet manipulating rod (2) is hinged with the hinging seat (15), and the other end of the water outlet manipulating rod (2) penetrates through the through hole (16) and is arranged outside the pot lid body (1) to form an operating end part (22) for people to press.

7. The pot lid structure according to claim 6, which is characterized in that: the above-mentioned pot lid body (1) is also provided with a surface lid (10) which can be covered on the pot lid body (1).

8. The pot lid structure according to claim 6, which is characterized in that: the above-mentioned pot lid body (1) is also provided with a connecting rod (20) which penetrates through the middle of the pot lid body (1).

9. The pot lid structure according to claim 1, which is characterized in that: a ring groove (13) is also arranged on the outer wall of the lower part of the above-mentioned pot lid body (1), and a sealing rubber ring (9) is installed in the ring groove (13).
